(19) United States
(12) Patent Application Publication
(10) Pub. No.: US 2022/0161795 A1
(43) Pub. Date: May 26, 2022

(54) IMAGE PROCESSING APPARATUS, DRIVING ASSISTANCE APPARATUS, AND VEHICLE

(71) Applicant: HONDA MOTOR CO., LTD., Tokyo (JP)

(72) Inventors: Atsushi ISHIOKA, Wako-shi (JP); Akito KOKUBO, Wako-shi (JP); Kovi ADUAYOM AHEGO, Wako-shi (JP)

(21) Appl. No.: 17/518,922

(22) Filed: Nov. 4, 2021

(30) Foreign Application Priority Data
Nov. 26, 2020 (JP) 2020-196327

(51) Int. Cl. B60W 30/12; B60W 30/165; B60W 50/14

(52) U.S. Cl. CPC B60W 30/12; B60W 30/165; B60W 50/14; B60W 2420/42; B60W 2400/00; B60W 2420/52; B60W 2050/146

(57) ABSTRACT

An image processing apparatus to be mounted on a vehicle, comprising a first acquisition unit that acquires information on a traveling path, and a first display unit that displays the traveling path based on an acquisition result of the first acquisition unit, wherein the first display unit displays the first branch lane as the adjacent lane on the one side of the current lane while the current lane is adjacent to the first branch lane, and then continues to display the adjacent lane such that the second branch lane is displayed as the adjacent lane, instead of the first branch lane while the current lane is adjacent to the second branch lane.

### CROSS-REFERENCE TO RELATED APPLICATION(S)

This application claims priority to and the benefit of Japanese Patent Application No. 2020-196327, filed on Nov. 26, 2020, the entire disclosure of which is incorporated herein by reference.

### BACKGROUND OF THE INVENTION

### Field of the Invention

The present invention relates to an image processing apparatus to be mounted on a vehicle.

### Description of the Related Art

Some vehicles are equipped with a display device that displays the state of surroundings of a self-vehicle for an occupant (including a driver). Japanese Patent Laid-Open No. 2017-41126 describes displaying the state of surroundings of a self-vehicle in a relatively simple manner to allow an occupant to recognize the state.

There is a case where a branch lane diverges from a current lane in which a self-vehicle is currently traveling on a traveling path. There may be a demand for a display mode that allows an occupant to easily recognize the fact (or a display mode that does not confuse the occupant) in such a case.

### SUMMARY OF THE INVENTION

The present invention causes the state of surroundings of a self-vehicle to be displayed in a relatively simple manner when a branch lane diverges from a current lane

One of the aspects of the present invention provides an image processing apparatus to be mounted on a vehicle, the apparatus comprising a first acquisition unit that acquires information on a traveling path; and a first display unit that displays the traveling path based on a result of acquisition performed by the first acquisition unit, wherein in a case where the traveling path includes a current lane in which a self-vehicle is currently traveling and a branch lane diverging from the current lane, the first display unit vertically displays the current lane, and also vertically displays the branch lane as an adjacent lane such that the current lane and the branch lane are horizontally arranged side by side, and in a case where there are two adjacent branch lanes diverging from one side of the current lane, one of the two branch lanes located closer to the self-vehicle in a traveling direction of the self-vehicle being defined as a first branch lane, another branch lane being defined as a second branch lane, the first display unit displays the first branch lane as the adjacent lane on the one side of the current lane while the current lane is adjacent to the first branch lane, and then continues to display the adjacent lane such that the second branch lane is displayed as the adjacent lane, instead of the first branch lane while the current lane is adjacent to the second branch lane.

Further features of the present invention will become apparent from the following description of exemplary embodiments with reference to the attached drawings.

### BRIEF DESCRIPTION OF THE DRAWINGS

FIG. 1 is a diagram for describing a configuration example of a vehicle according to an embodiment;

FIGS. 2A and 2B are diagrams for describing examples of a display mode of a display device;

FIG. 3 is a diagram for describing another example of the display mode of the display device;

FIGS. 4A to 4D are diagrams for describing another example of the display mode of the display device;

FIGS. 5A to 5D are diagrams for describing another example of the display mode of the display device

FIGS. 6A to 6D are diagrams for describing another example of the display mode of the display device

FIGS. 7A to 7F are diagrams for describing another example of the display mode of the display device.

### DESCRIPTION OF THE EMBODIMENTS

Hereinafter, an embodiment will be described in detail with reference to the accompanying drawings. Note that the following embodiment does not limit the invention according to the claims, and not all combinations of features described in the embodiment are essential to the invention. Two or more of a plurality of the features described in the embodiment may be freely combined. In addition, the same or similar constituent elements are denoted by the same reference numerals, and redundant description will be omitted.

(Configuration of Vehicle)

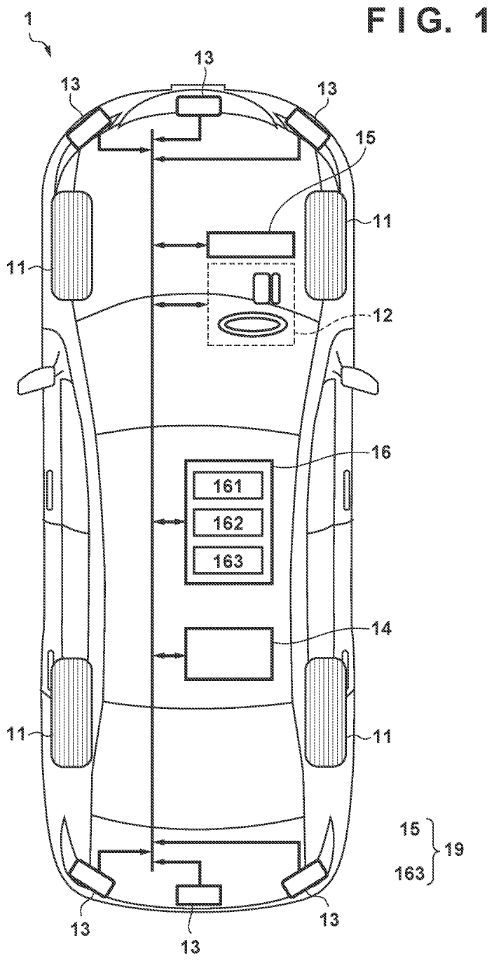

FIG. 1 shows a configuration example of a vehicle 1 according to an embodiment. The vehicle 1 includes wheels 11, a driving operation device 12, a monitoring device 13, a storage device 14, a display device 15, and an arithmetic device 16. The vehicle 1 further includes known constituent elements for implementing a function as the vehicle 1, such as a power source and a power transmission mechanism. However, detailed description thereof will be omitted here.

In the present embodiment, the vehicle 1 is a four-wheeled vehicle including a pair of left and right front wheels and a pair of left and right rear wheels as the wheels 11, but the number of the wheels 11 is not limited to the present example. For example, as another embodiment, the vehicle 1 may be a two-wheeled vehicle, a three-wheeled vehicle, or the like. Alternatively, a crawler type vehicle may be adopted which includes the wheels 11 as a part thereof.

The driving operation device 12 includes an acceleration operator, a braking operator, a steering operator, and the like, as operators for performing driving operation (mainly acceleration, braking, and steering) of the vehicle 1. An accelerator pedal is typically used as the acceleration operator. A brake pedal is typically used as the braking operator. In addition, a steering wheel is typically used as the steering operator. The method of operating the operators is not limited to the present example, and other configurations such as a lever type operator and a switch type operator may be adopted as the operators.

The monitoring device 13 is configured to monitor a situation outside the vehicle. One or more monitoring devices 13 are installed at predetermined positions on the body of the vehicle. A known vehicle-mounted sensor necessary for implementing automated driving to be described below is used as the monitoring device 13. Examples of such a vehicle-mounted sensor include a radar (millimeter-wave radar), a light detection and ranging (LIDAR), and an imaging camera. As a result, the monitoring device 13 can detect surrounding environment or traveling environment of the vehicle 1 (for example, another vehicle currently traveling in the vicinity of the vehicle 1, or a fallen object on a traveling path on which the vehicle 1 is currently traveling). The monitoring device 13 may be referred to as a detection device or the like.

A nonvolatile memory is used as the storage device 14. Examples of such a nonvolatile memory include an electrically erasable programmable read-only memory (EEPROM) and a hard disk drive (HDD). The storage device 14 stores map data necessary for implementing automated driving to be described below. The present embodiment is based on the assumption that the map data are prepared in advance and stored in the storage device 14. However, as another embodiment, the map data may be acquired through external communication and stored in the storage device 14, and may be updated as necessary.

The display device 15 can display, on the map data, a position where the vehicle 1 (may be referred to as “self-vehicle 1” in the following description so as to be distinguished from another vehicle) is located/traveling. Details will be described below A known device such as a liquid crystal display just needs to be used as the display device 15. The display device 15 can display, on the map data, a position of the vehicle 1 pinpointed on the basis of external communication with, for example, a global positioning system (GPS).

The display device 15 is installed in the front part of a cabin, and is positioned such that the display device 15 can be easily seen by a driver or an occupant. For example, the display device 15 may be built into an instrument panel. For example, the display device 15 may be provided in parallel with a measuring instrument, or may be installed between two or more measuring instruments. As an example, the display device 15 may be installed between a tachometer and a speedometer in the instrument panel.

Typically, the arithmetic device 16 includes one or more electronic control units (ECUs) each including a central processing unit (CPU) and a memory, and performs predetermined arithmetic processing. A volatile memory is used as the memory, and examples thereof include a dynamic random access memory (DRAM) and a static random access memory (SRAM). That is, the function of the arithmetic device 16 can be implemented by the CPU executing a predetermined program by using data or information read from the storage device 14 and developed in the memory.

In the present embodiment, the arithmetic device 16 includes a monitoring ECU 161, a driving operation ECU 162, and an image processing ECU 163, which can communicate with each other. The monitoring ECU 161 functions as an external environment analysis device that analyzes a result of monitoring performed by the monitoring device 13 (a result of detection of the surrounding environment or traveling environment of the vehicle 1). The monitoring ECU 161 determines the presence or absence of another vehicle and the presence or absence of another target (mainly a fallen object) on the basis of the result of monitoring performed by the monitoring device 13. The monitoring ECU 161 determines the attributes of an object detected by the monitoring device 13 by pattern matching or the like, so that it is possible to determine whether the object is a vehicle or another target.

The driving operation ECU 162 can control the drive of the driving operation device 12 in place of the driver, that is, perform automated driving on the basis of a result of the above-described analysis performed by the monitoring ECU 161. Thus, the driving operation ECU 162 functions as an automated driving device. Here, automated driving means that the driving operation ECU 162 performs driving operation. That is, the vehicle 1 has, as operation modes, a manual driving mode and an automated driving mode. In the manual driving mode, driving operation is performed by the driver. In the automated driving mode, driving operation is performed by the driving operation ECU 162.

The image processing ECU 163 functions as an image processing apparatus capable of displaying a predetermined image on the display device 15. The image processing ECU 163 indicates the position of the self-vehicle 1 on the map data in the case of automated driving described above. Meanwhile, the position of the self-vehicle 1 may be indicated collaterally also in the case of manual driving.

The display device 15 and the image processing ECU 163 described above perform driving assistance by displaying the state of surroundings of the self-vehicle 1. Therefore, the display device 15 and the image processing ECU 163 may be integrated into a driving assistance apparatus 19 from this viewpoint. The concept of driving assistance includes not only automated driving described above, but also reduction of a burden on a driver or an occupant in manual driving, such as execution of part of driving operation by the driving operation ECU 162. Therefore, the driving assistance apparatus 19 may further include the monitoring ECU 161 and the driving operation ECU 162 so that the driving assistance apparatus 19 can determine a travel route of the self-vehicle 1, notify the driver of the travel route, or perform automated driving on the basis of the travel route.

The above-described arithmetic device 16 may include a single ECU. That is, the above-described ECUs 161 to 163 may be configured as a single unit. In addition, a known semiconductor device such as an application specific integrated circuit (ASIC) may be used instead of the ECU. That is, the function of the arithmetic device 16 can be implemented by either software or hardware. In addition, the arithmetic device 16 also functions as a system controller that controls the entire system of the vehicle 1 by communicating with the driving operation device 12, the monitoring device 13, the storage device 14, and the display device 15. Thus, the arithmetic device 16 may be referred to as a control device.

(Display Mode of Display Device)

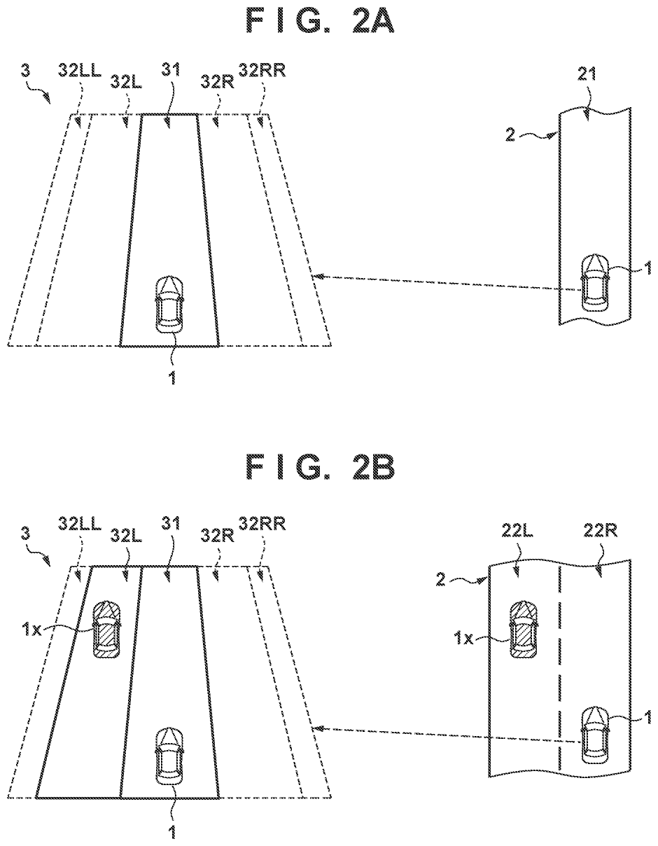

FIGS. 2A and 2B are schematic diagrams showing examples of the display mode of the display device 15. The display device 15 provides a display image 3 in which a lane 21 where the self-vehicle 1 is currently traveling (hereinafter, simply referred to as a “current lane” in some cases) is displayed as a current lane 31. In addition, when there is a lane (hereinafter, simply referred to as an “adjacent lane” in some cases) adjacent to the current lane 21, the display device 15 can display the adjacent lane as an adjacent lane 32L or 32R. Note that, for the sake of distinction, an adjacent lane on the left of the current lane 31 is defined as the adjacent lane 32L, and an adjacent lane on the right of the current lane 31 is defined as the adjacent lane 32R.

In the present embodiment, when there is another adjacent lane on the left of the left adjacent lane 32L, the display device 15 can provide the display image 3 in which part of a lane 32LL is further displayed. Similarly, when there is another adjacent lane on the right of the right adjacent lane 32R, the display device 15 can further display part of a lane 32RR. In the present embodiment, it is possible to simplify the display image 3 by partially displaying the lanes 32LL and 32RR. However, as another embodiment, the entire lanes 32LL and 32RR may be displayed.

FIG. 2A shows an example of a case where a traveling path 2 on which the vehicle 1 is currently traveling has a single lane. According to the example of FIG. 2A, there is no lane adjacent to the current lane 21. Therefore, in the display image 3, the current lane 31 is displayed, while the adjacent lanes 32L and 32R on the left side and right side of the current lane 31 are hidden. Furthermore, in the display image 3, the self-vehicle 1 is displayed in a lower part of the current lane 31.

FIG. 2B shows an example of a case where the traveling path 2 has two lanes, the self-vehicle 1 is traveling in a lane 22R on the right side, and another vehicle 1X is traveling ahead in a lane 22L on the left side. Therefore, according to the example of FIG. 2B, the current lane 31 and the adjacent lane 32L on the left side are displayed, and the other lanes (the adjacent lane 32R on the right side and the lanes 32LL and 32RR) are hidden. Furthermore, in the display image 3, the self-vehicle 1 is displayed in the lower part of the current lane 31, and in the example of FIG. 2B, the another vehicle 1X is displayed in the adjacent lane 32L on the left side.

Note that, in the display image 3, the current lane 31 and another lane (adjacent lane 32L or the like) are each shown in a straight line in a vertical direction such that the current lane 31 is accompanied by the another lane, regardless of the presence or absence of a curve in the traveling path 2. Moreover, the traveling path 2 in the display image 3 is drawn in perspective in the present embodiment, but may be drawn in a planar view as another embodiment.

In addition, the another vehicle 1X may be included in the display image 3 in a case where the another vehicle 1X is located around the self-vehicle 1. Meanwhile, it is desirable that more vehicles (or objects, such as fallen object described later) located in front of the self-vehicle 1 be displayed as other vehicles 1X than vehicles (or objects) located at the side or rear of the self-vehicle 1. Therefore, the self-vehicle 1 is preferably displayed in the lower part of the display image 3.

To sum up, the display device 15 provides the display image 3 in which the current lane 31 is vertically displayed and the adjacent lanes 32L and 32R are also vertically displayed such that the current lane 31 and the adjacent lanes 32L and 32R are horizontally arranged side by side. Thus, the display device 15 schematically displays the position of the self-vehicle 1 on the map data together with the state of surroundings of the self-vehicle 1. In other words, the display image 3 includes display areas in which the lanes 31, 32L, and 32R can be individually displayed. Each area is displayed when a corresponding lane exists, and is hidden when no corresponding lane exists. In the drawings, a displayed object is indicated by a thick solid line, and a hidden object is indicated by a thin broken line (the same applies to other drawings to be described below). Thus, the display device 15 provides relatively simple display modes. This enables an occupant to easily grasp the state of surroundings of the vehicle 1.

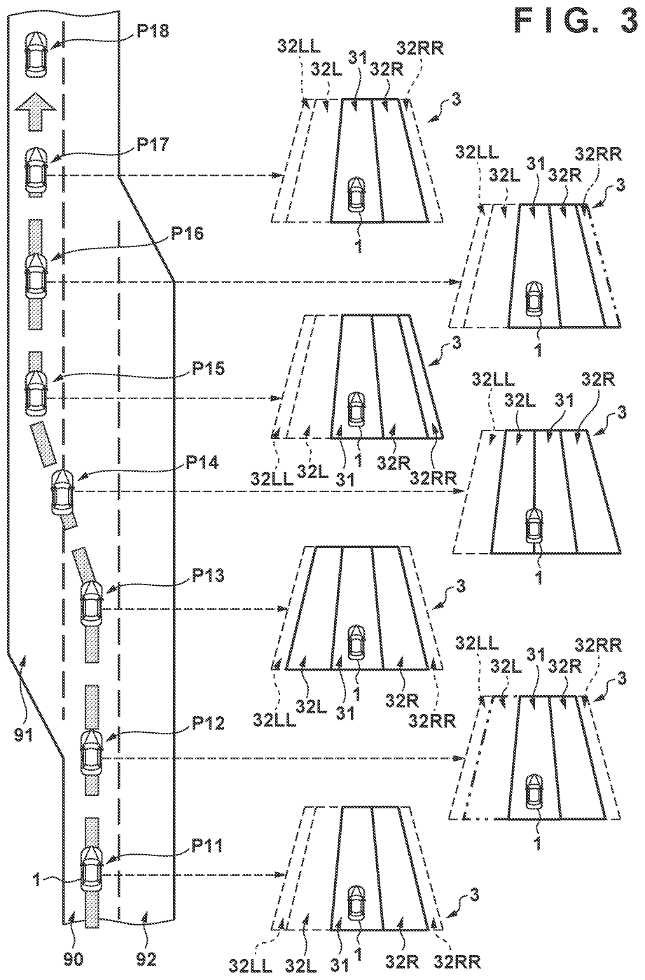

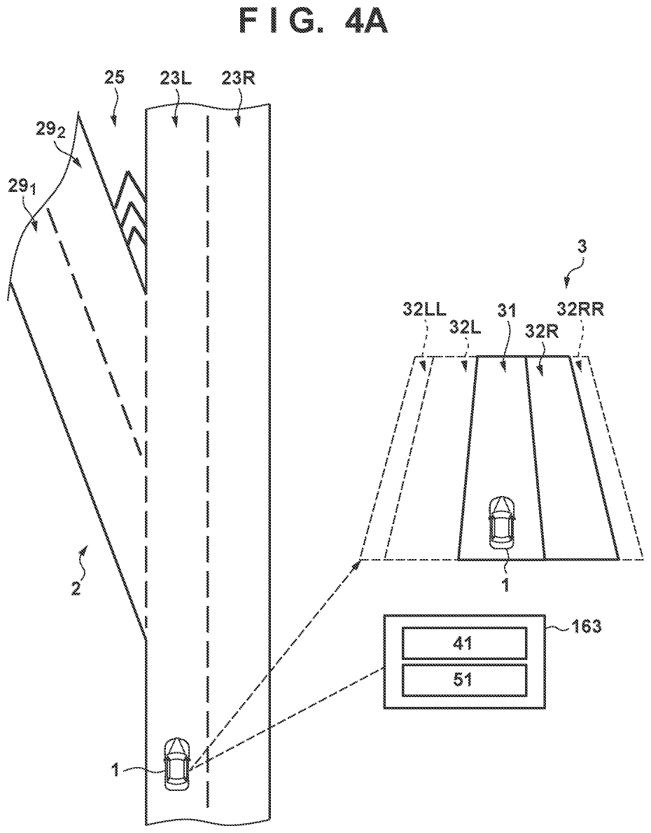

FIG. 3 shows an example of the display image 3 in the case of the traveling path 2 that has a lane 90 extending from point P11 to point P18, a lane 91 extending from point P12 to point P18 on the left side of the lane 90, and a lane 92 extending from point P11 to point P17 on the right side of the lane 90. It is assumed that the lane 91 starts at point P12 and gradually increases in width between points P12 and P13, and the lane 92 gradually decreases in width between points P16 and P17 and ends at point P17.

The present example is based on the assumption that, as indicated by a broken arrow, the vehicle 1 travels in the lane 90 between points P11 and P13, moves from the lane 90 to the lane 91 between points P13 and P15, and then travels in the lane 91 between points P15 and P18. Note that for ease of description, it is assumed here that no other vehicle is traveling/exists in the vicinity of the self-vehicle 1.

At point P11, the vehicle 1 is traveling in the lane 90, and the adjacent lane 92 exists on the right side of the lane 90. Therefore, the current lane 31 and the adjacent lane 32R are displayed, and the other lanes are hidden in the display image 3. In this state, the occupant can visually recognize the current lane 31 and the adjacent lane 32R.

The adjacent lane 91 starts at point P12 on the left side of the current lane 90. Therefore, in the display image 3, the current lane 31 and the adjacent lane 32R are displayed, and in addition, the adjacent lane 32L on the left side of the current lane 31 is faded in to be newly displayed. In this state, the occupant can visually recognize the start of the adjacent lane 32L. Note that the lane newly displayed with a fade-in effect is indicated by an alternate long and short dash line in FIG. 3 and other drawings to be described below.

At point P13, the vehicle 1 is traveling in the lane 90, and the adjacent lanes 91 and 92 exist on both sides of the lane 90. Therefore, in the display image 3, the current lane 31 and the adjacent lanes 32L and 32R are displayed, and the other lanes are hidden. In this state, the occupant can visually recognize the current lane 31 and the adjacent lanes 32L and 32R.

At point P14, the vehicle 1 moves leftward from the lane 90 to the lane 91. After the movement, the lane 91 is newly regarded as the current lane, and the adjacent lane 90 exists on the right side of the current lane. In addition, another lane, that is, the lane 92 exists on the right side of the adjacent lane 90. Therefore, in the display image 3, the vehicle 1 continues to be displayed (the position of the vehicle 1 in the display image 3 does not change), and the current lane 31 and the adjacent lanes 32L and 32R slide rightward. Note that the right side part of the adjacent lane 32R is not included in the display image 3.

As a result, the former adjacent lane 32L is displayed as the new current lane 31, the former current lane 31 is displayed as the new adjacent lane 32R, and the former adjacent lane 32R is displayed as the new lane 32RR. That is, the new current lane 31 corresponds to the lane 91, the new adjacent lane 32R corresponds to the lane 90, and the new lane 32RR corresponds to the lane 92. In this state, the occupant can visually recognize the current lane 31, the adjacent lane 32R, and the lane 32RR.

At point P15, the vehicle 1 is traveling in the lane 91, the adjacent lane 90 exists on the right side of the lane 91, and the lane 92 exists on the right side of the adjacent lane 90. Therefore, in the display image 3, the current lane 31, the adjacent lane 32R, and the lane 32RR are displayed, and the other lanes are hidden. In this state, the occupant can visually recognize the current lane 31, the adjacent lane 32R, and the lane 32RR.

At point P16, the vehicle 1 is traveling in the lane 91, and the adjacent lane 90 exists on the right side of the lane 91, while the lane 92 on the right side of the adjacent lane 90 ends. Therefore, in the display image 3, the lane 32RR is faded out and restrained from being displayed, while the current lane 31 and the adjacent lane 32R continue to be displayed. In this state, the occupant can visually recognize the current lane 31 and the adjacent lane 32R. Note that the lane faded out and restrained from being displayed is indicated by a two-dot chain line in FIG. 3 and other drawings to be described below.

At point P17, the vehicle 1 is traveling in the lane 91, and the adjacent lane 90 exists on the right side of the lane 91. Therefore, the current lane 31 and the adjacent lane 32R are displayed, and the other lanes are hidden in the display image 3. The same applies to point P18. In this state, the occupant can visually recognize the current lane 31 and the adjacent lane 32R.

Note that, in the above example, the start/end of the adjacent lanes 32L and 32R is represented by fade-in/out in the display image 3, but may be represented by any of known display modes such as random stripes, wipe effect, and split effect.

Incidentally, there is a case where a branch lane diverges from the current lane on the traveling path 2. Thus, there is a demand for a display mode that allows an occupant to easily recognize the fact, or a display mode that does not confuse the occupant in such a case. The above-described display mode (see FIG. 3) enables the occupant to easily grasp the state of surroundings of the vehicle 1 even in such a case. This will be described below with reference to several examples.

### First Example

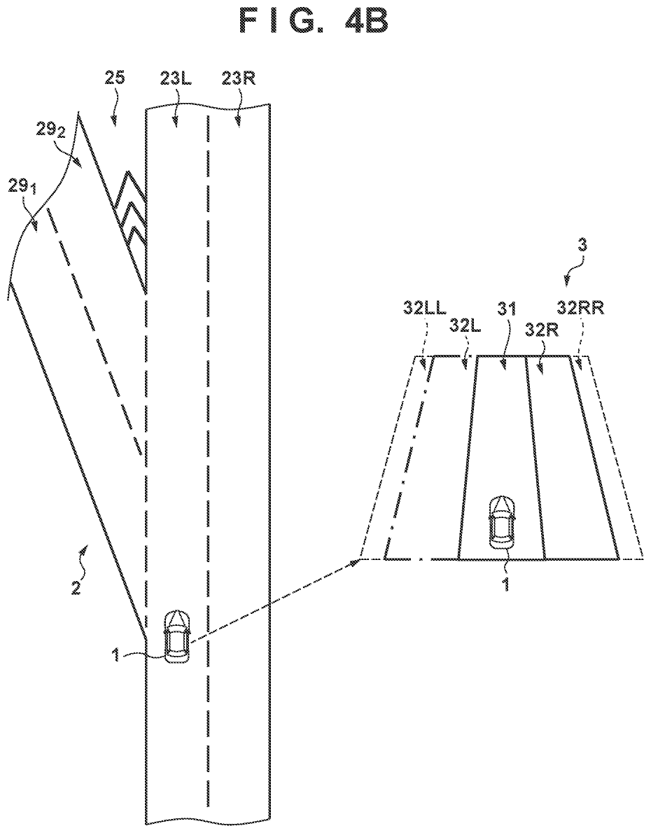

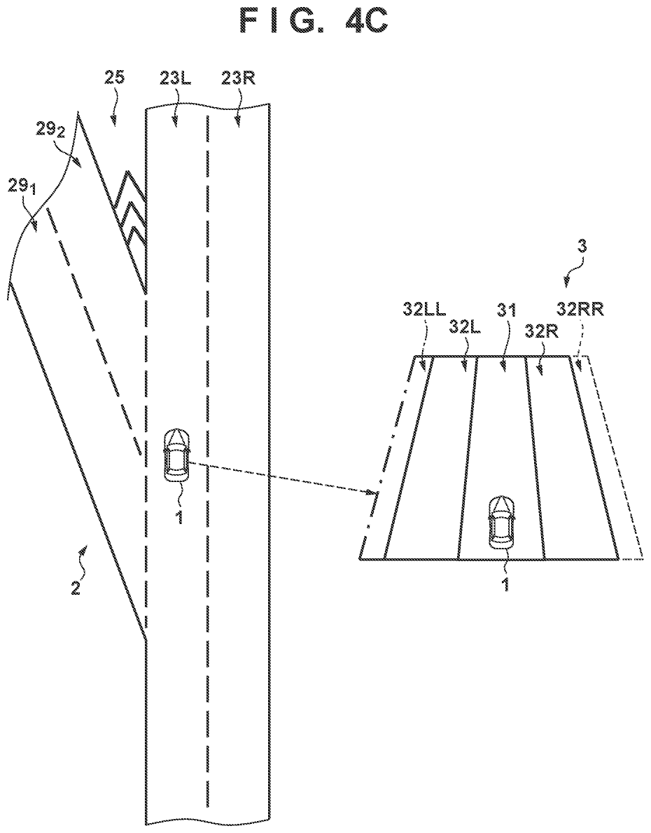

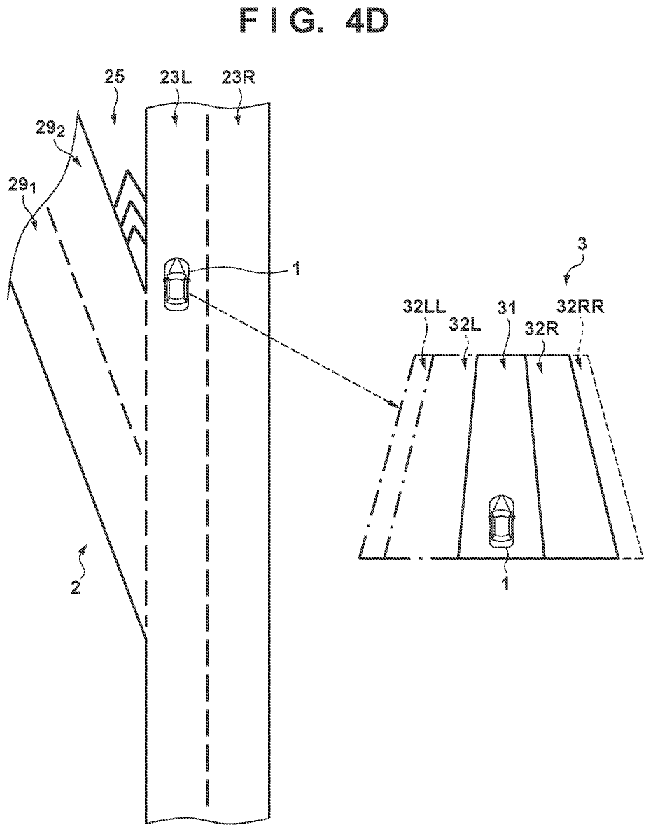

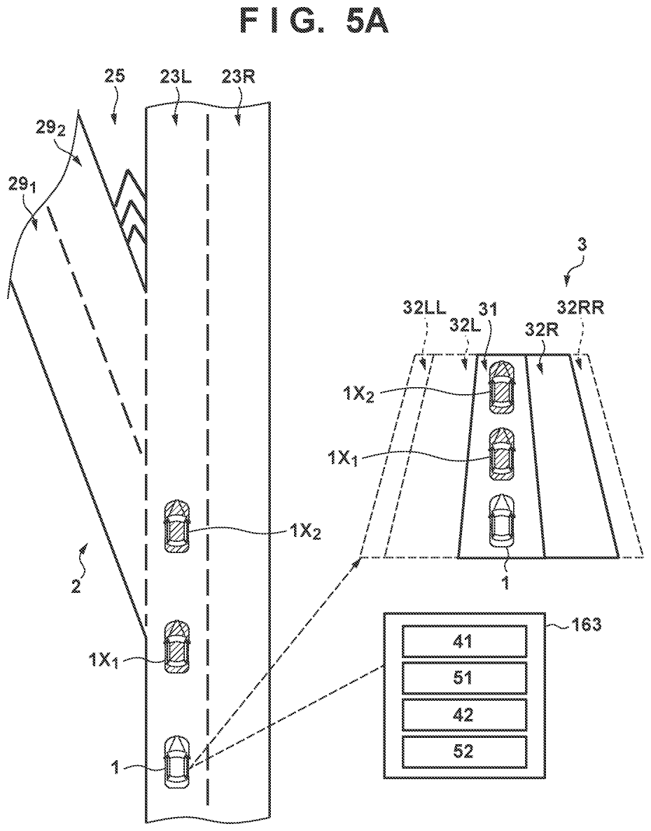

The state of the traveling path 2 according to a first example and a display mode of the corresponding display image 3 will be described with reference to FIGS. 4A to 4D. The traveling path 2 has two lanes. A left lane is defined as a lane 23L, and a right lane is defined as a lane 23R in the present example. The self-vehicle 1 travels straight in the lane 23L. A situation changes in the order of FIGS. 4A, 4B, 4C, and 4D over time. In addition, two branch lanes 29₁ and 29₂ diverge from the left side of the current lane 23L. Here, one of the two branch lanes located closer to the self-vehicle 1 in its traveling direction is defined as the branch lane 29₁, and the other is defined as the branch lane 29₂. Note that the lanes 23L and 23R can also be referred to as main lines, and the branch lanes 29₁ and 29₂ can also be referred to as branch lines.

First, FIG. 4A shows the state of the traveling path 2 before the branch lanes 29₁ and 29₂ diverge from the current lane 23L, and a display mode of the display image 3 in the self-vehicle 1 at that time. As shown in the drawing, the image processing ECU 163 includes an acquisition unit 41 and a display unit 51. The acquisition unit 41 acquires information on the traveling path 2 based on map data. The display unit 51 causes the display device 15 to display the traveling path 2 based on a result of acquisition performed by the acquisition unit 41. In the example of FIG. 4A, the lane 23R is located on the right side of the current lane 23L, and is adjacent to the current lane 23L. Therefore, the display unit 51 provides the display image 3 in which the current lane 31 and the adjacent lane 32R on the right side thereof are displayed.

Next, FIG. 4B shows a state in which the lane 23L has become adjacent to the branch lane 29₁ on the left side as a result of the self-vehicle 1 traveling straight in the lane 23L. Therefore, the display unit 51 provides the display image 3 in which the current lane 31 and the adjacent lane 32R on the right side of the current lane 31 are displayed, and in addition, the adjacent lane 32L on the left side of the current lane 31 is faded in to be newly displayed.

Thereafter, FIG. 4C shows a state in which the lane 23L has become adjacent to the branch lane 29₂ on the left side as a result of the self-vehicle 1 further traveling straight in the lane 23L. Therefore, the display unit 51 continues to display the adjacent lane 32L in such a way as to display the branch lane 29₂ as the adjacent lane 32L, while the branch lane 29₁ was being displayed as the adjacent lane 32L until then. In addition, the display unit 51 newly displays the lane 32LL indicating the branch lane 29₁ with a fade-in effect.

Then, FIG. 4D shows a state in which the branch lane 29₁ and the branch lane 29₂ have both been separated from the current lane 23L as a result of the self-vehicle 1 further traveling straight in the lane 23L. In the present example, it is assumed that a traveling prohibited zone 25 is provided between the current lane 23L and the branch lane 29₂, so that the branch lane 29₂ is separated from the current lane 23L. Therefore, the display unit 51 fades out the adjacent lane 32L that was indicating the branch lane 29₂ until then and the lane 32LL that was indicating the branch lane 29₁ until then, and restrains the adjacent lane 32L and the lane 32LL from being displayed.

As described above, according to the present example, when the traveling path 2 includes a current lane and a branch lane, the display unit 51 vertically displays the current lane 31, and also vertically displays the branch lane as the adjacent lane 32L or 32R such that the current lane 31 and the branch lane are horizontally arranged side by side.

Here, regarding the two branch lanes 29₁ and 29₂ diverging from one side (the left side in the present example) of the current lane 23L, one of the two branch lanes 29₁ and 29₂ located closer to the self-vehicle 1 in its traveling direction is defined as the branch lane 29₁, and the other is defined as the branch lane 29₂. While the current lane 23L is adjacent to the branch lane 29₁, the display unit 51 displays the branch lane 29₁ as the adjacent lane 32L on the one side of the current lane 31. Thereafter, while the current lane 23L is adjacent to the branch lane 29₂, the display unit 51 continues to display the adjacent lane 32L in such a way as to display the branch lane 29₂ as the adjacent lane 32L, while the branch lane 29₁ was being displayed as the adjacent lane 32L until then.

Even when the branch lanes 29₁ and 29₂ start/end at any point on the traveling path 2, such a display mode does not confuse the occupant by, for example, repeatedly displaying/hiding the adjacent lane 32L, so that it is possible to enable the occupant to easily grasp the state of surroundings of the vehicle 1.

### Second Example

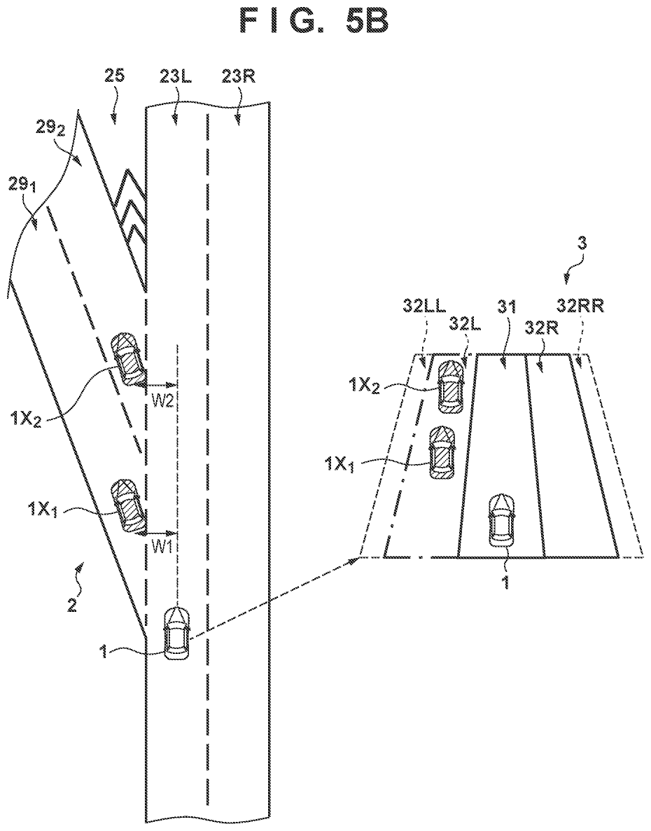

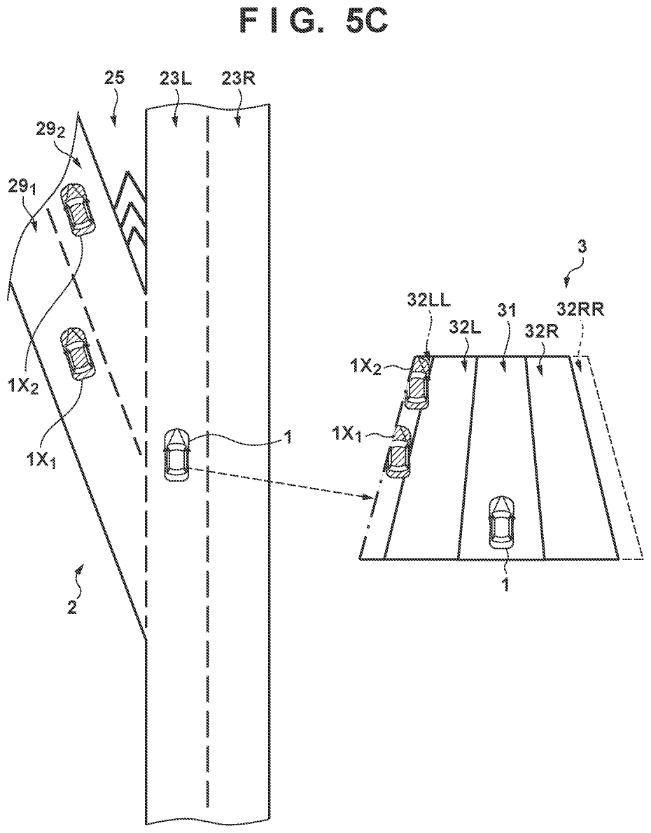

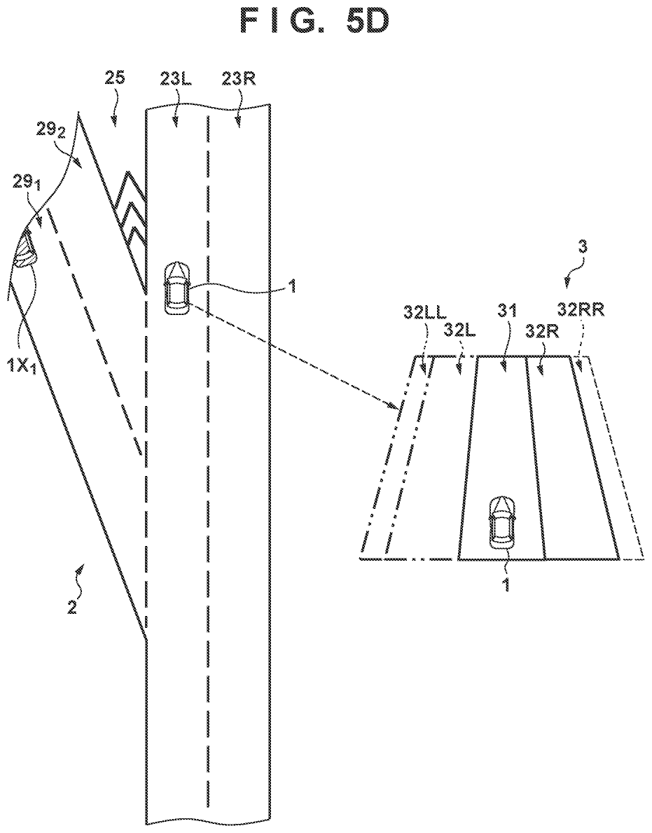

The state of the traveling path 2 according to a second example and a display mode of the corresponding display image 3 will be described with reference to FIGS. 5A to 5D, as in the first example described above (see FIGS. 4A to 4D). The present example is different from the first example in that other vehicles 1X₁ and 1X₂ are traveling ahead of the self-vehicle 1. It is assumed that the self-vehicle 1 travels straight in the lane 23L, while the other vehicle 1X₁ traveling in front of the self-vehicle 1 moves from the lane 23L to the branch lane 29₁, and the other vehicle 1X₂ traveling in front of the other vehicle 1X₁ moves from the lane 23L to the branch lane 29₂.

The image processing ECU 163 further includes an acquisition unit 42 and a display unit 52. The acquisition unit 42 acquires, from the monitoring ECU 161, information indicating positions of the other vehicles 1X₁ and 1X₂, which are traveling in the vicinity of the self-vehicle 1, relative to the self-vehicle 1. The display unit 52 causes the display device 15 to display the other vehicles 1X₁ and 1X₂ in such a way as to superimpose the other vehicles 1X₁ and 1X₂ on information displayed by the display unit 51 on the basis of a result of acquisition performed by the acquisition unit 42.

In the example of FIG. 5A, the display unit 51 provides the display image 3 in which the current lane 31 and the adjacent lane 32R on the right side of the current lane 31 are displayed, as in FIG. 4A. Furthermore, since the other vehicles 1X₁ and 1X₂ are traveling in front of the self-vehicle 1, the display unit 52 displays the other vehicles 1X₁ and 1X₂ in front of the self-vehicle 1 in the display image 3.

In the example of FIG. 5B, the display unit 51 provides the display image 3 in which the current lane 31 and the adjacent lane 32R on the right side of the current lane 31 are displayed, and in addition, the adjacent lane 32L on the left side of the current lane 31 is faded in to be newly displayed, as in FIG. 4B.

Here, as the relative positions of the other vehicles 1X₁ and 1X₂ that are the result of acquisition performed by the acquisition unit 42, W1 denotes a horizontal offset distance between the other vehicle 1X₁ and the self-vehicle 1, and W2 denotes a horizontal offset distance between the other vehicle 1X₂ and the self-vehicle 1. In the display image 3, the other vehicles 1X₁ and 1X₂ are indicated by their positions relative to the self-vehicle 1. For example, in a case where the offset distances W1 and W2 are equal to each other, the display unit 52 displays the branch lane 29₁ as the adjacent lane 32L, and also displays both the other vehicles 1X₁ and 1X₂ in the adjacent lane 32L while the current lane 23L is adjacent to the branch lane 29₁. That is, although the other vehicle 1X₁ is traveling in the branch lane 29₁ and the other vehicle 1X₂ is traveling in the branch lane 29₂, the other vehicles 1X₁ and 1X₂ are displayed based on their positions relative to the self-vehicle 1 in the display image 3. Therefore, in the case of the present example, the other vehicles 1X₁ and 1X₂ are both displayed in the same lane 32L based on the offset distances W1 and W2.

In the example of FIG. 5C, the display unit 51 continues to display the adjacent lane 32L in such a way as to display the branch lane 29₂ as the adjacent lane 32L, while the branch lane 29₁ was being displayed as the adjacent lane 32L until then. In addition, the display unit 51 newly displays the lane 32LL indicating the branch lane 29₁ with a fade-in effect, as in FIG. 4C. Here, since the other vehicles 1X₁ and 1X₂ have already been sufficiently separated from the self-vehicle 1, the other vehicles 1X₁ and 1X₂ are partially located outside the display image 3. However, the display unit 52 displays both the other vehicles 1X₁ and 1X₂ in the lane 32LL as the branch lane 29₁. Note that when the other vehicles 1X₁ and 1X₂ are located close to the self-vehicle 1, the other vehicles 1X₁ and 1X₂ are displayed in the adjacent lane 32L as the branch lane 29₂.

In the example of FIG. 5D, the display unit 51 fades out the adjacent lane 32L that was indicating the branch lane 29₂ until then and the lane 32LL that was indicating the branch lane 29₁ until then, and restrains the adjacent lane 32L and the lane 32LL from being displayed, as in FIG. 4D. Furthermore, since the other vehicles 1X₁ and 1X₂ have already been sufficiently separated from the self-vehicle 1, the other vehicles 1X₁ and 1X₂ are hidden (located outside the display image 3).

As described above, according to the present example, the positions of the other vehicles 1X₁ and 1X₂ relative to the self-vehicle 1 are indicated in the display image 3, regardless of the information displayed by the display unit 51. That is, the other vehicles 1X₁ and 1X₂ are displayed regardless of the number of lanes on the traveling path 2. Such a display mode achieves the effect of the first example, and avoids causing an occupant to be confused by the behavior of the other vehicles 1X₁ and 1X₂, so that it is possible to enable the occupant to easily grasp the state of surroundings of the vehicle 1.

Note that, for ease of understanding, the case of the two other vehicles 1X₁ and 1X₂ (the case where the number of the other vehicles 1X is two) has been cited here as an example, but the same applies to the case where the number of the other vehicles 1X is one, or three or more.

### Third Example

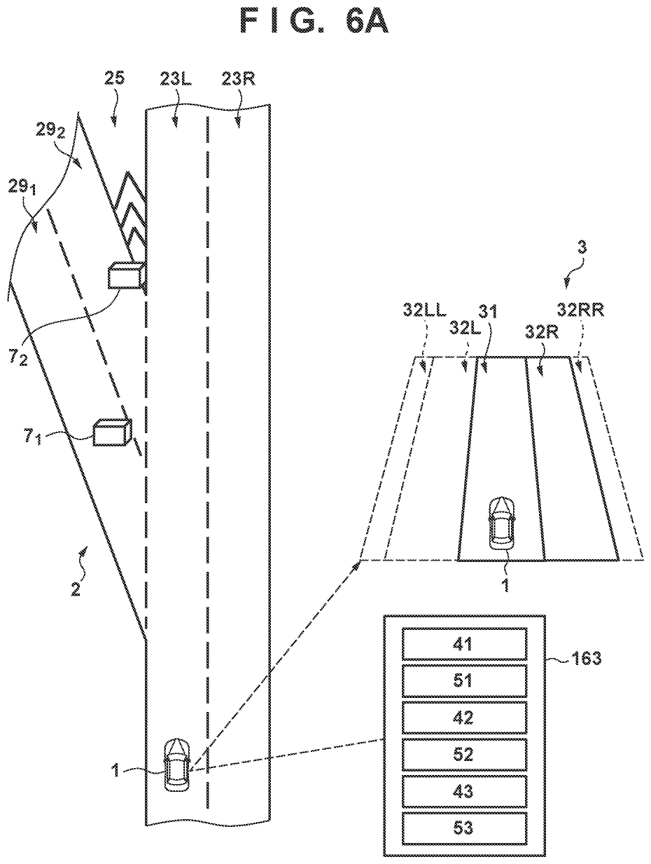

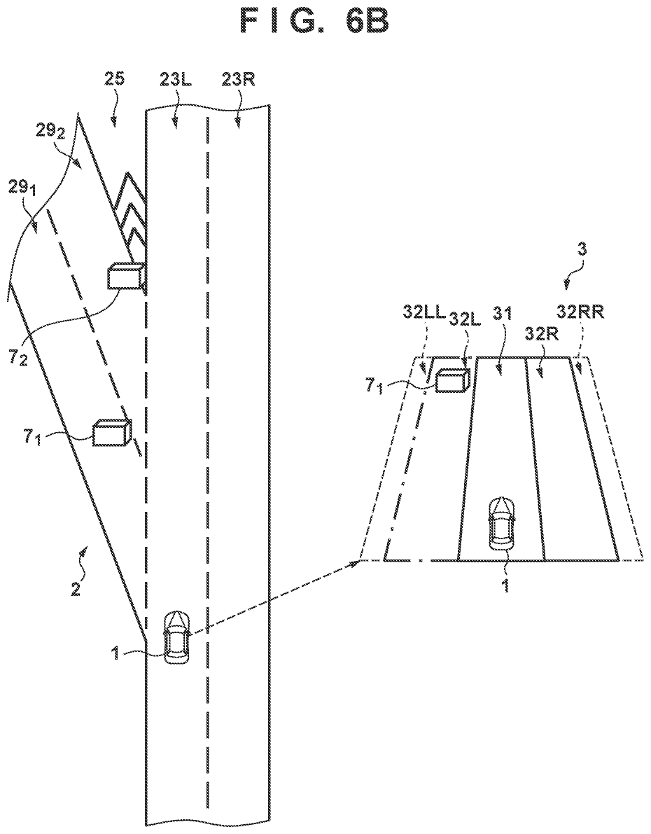

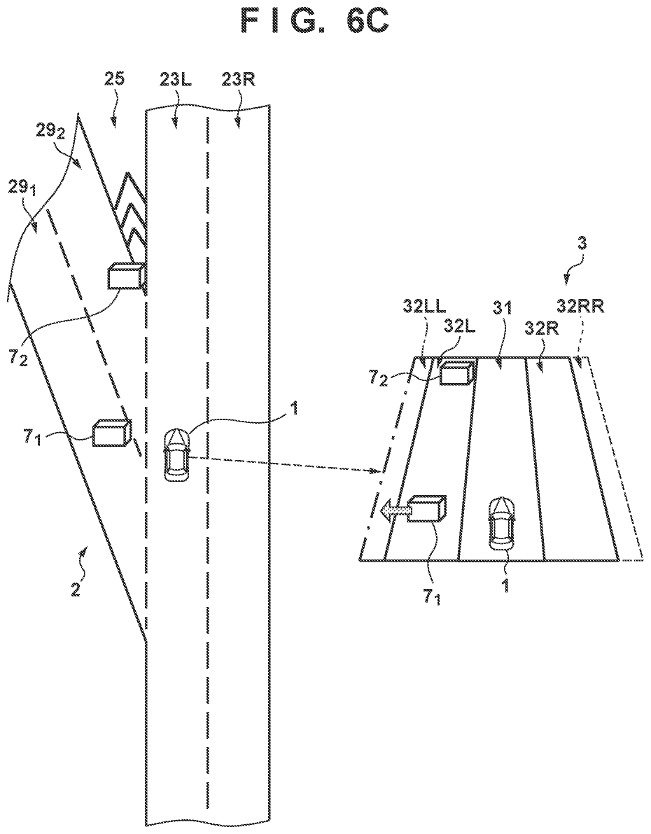

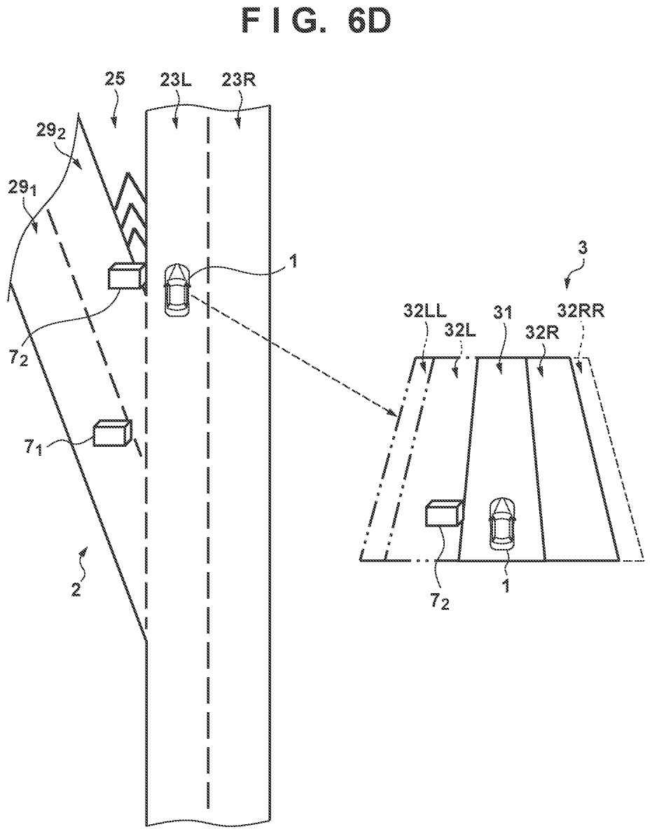

The state of the traveling path 2 according to a third example and a display mode of the corresponding display image 3 will be described with reference to FIGS. 6A to 6D, as in the first example described above (see FIGS. 4A to 4D). The present example is different from the first example in that fallen objects 7₁ and 7₂ exist on the traveling path 2. It is assumed that the fallen object 7₁ is located in the branch lane 29₁ and the fallen object 7₂ is located in the branch lane 29₂.

In the present example, the image processing ECU 163 further includes an acquisition unit 43 and a display unit 53. As described above, the monitoring ECU 161 can determine the presence or absence of another vehicle and the presence or absence of another target (mainly a fallen object) on the basis of the result of monitoring performed by the monitoring device 13. Regarding the fallen objects 7₁ and 7₂ located around the self-vehicle 1, the acquisition unit 43 acquires, from the monitoring ECU 161, information indicating positions of the fallen objects 7₁ and 7₂ relative to the self-vehicle 1. The display unit 53 causes the display device 15 to display the fallen objects 7₁ and 7₂ in such a way as to superimpose the fallen objects 7₁ and 7₂ on information displayed by the display unit 51, on the basis of a result of acquisition performed by the acquisition unit 43.

In the example of FIG. 6A, the display unit 51 provides the display image 3 in which the current lane 31 and the adjacent lane 32R on the right side of the current lane 31 are displayed, as in FIG. 4A.

In the example of FIG. 6B, the display unit 51 provides the display image 3 in which the current lane 31 and the adjacent lane 32R on the right side of the current lane 31 are displayed, and in addition, the adjacent lane 32L on the left side of the current lane 31 is faded in to be newly displayed, as in FIG. 4B. Here, the adjacent lane 32L indicates the branch lane 29₁, and the fallen object 7₁ is located in the branch lane 29₁. Therefore, in the present example, the display unit 53 displays the fallen object 7₁ in the adjacent lane 32L.

In the example of FIG. 6C, the display unit 51 continues to display the adjacent lane 32L. In addition, the display unit 51 newly displays the lane 32LL with a fade-in effect, as in FIG. 4C. Here, the lane 32LL indicates the branch lane 29₁, and the adjacent lane 32L indicates the branch lane 29₂. The fallen object 7₁ is located in the branch lane 29₁, and the fallen object 7₂ is located in the branch lane 29₂. The fallen object 7₁ may be displayed together with the fallen object 7₂ in the same lane 32L based on offset distances as in the above-described method of displaying the other vehicle 1X₁ shown in FIG. 5B. However, when another vehicle and the fallen objects can be distinguished from each other as in the present example, the display unit 53 may slide the display position of the fallen object 7₁ into the lane 32LL as indicated by an arrow in the present example (alternatively, an image may be displayed such that the fallen object 7₁ is not included in the image). The sliding of the display position may be performed substantially simultaneously with the fade-in of the lane 32LL. Meanwhile, the display unit 53 displays the fallen object 7₂ in the adjacent lane 32L.

In the example of FIG. 6D, the display unit 51 restrains the adjacent lane 32L and the lane 32LL from being displayed, by fading out the adjacent lane 32L and the lane 32LL, as in FIG. 4D. The adjacent lane 32L and the lane 32LL are restrained from being displayed. At the same time, the fallen objects 7₁ and 7₂ are also hidden by the display unit 53.

According to the present example, the display unit 53 displays the fallen objects 7₁ and 7₂ in association with the branch lanes 29₁ and 29₂ corresponding to the lanes 32LL and 32L displayed with a fade-in effect, respectively. In addition, the display unit 53 restrains the fallen objects 7₁ and 7₂ from being displayed, in association with the branch lanes 29₁ and 29₂ corresponding to the lanes 32LL and 32L faded out and restrained from being displayed, respectively. Such a display mode can avoid confusing an occupant, by displaying the branch lanes 29₁ and 29₂ and the fallen objects 7₁ and 7₂ in association with each other, so that it is possible to enable the occupant to easily grasp the state of surroundings of the vehicle 1.

### Fourth Example

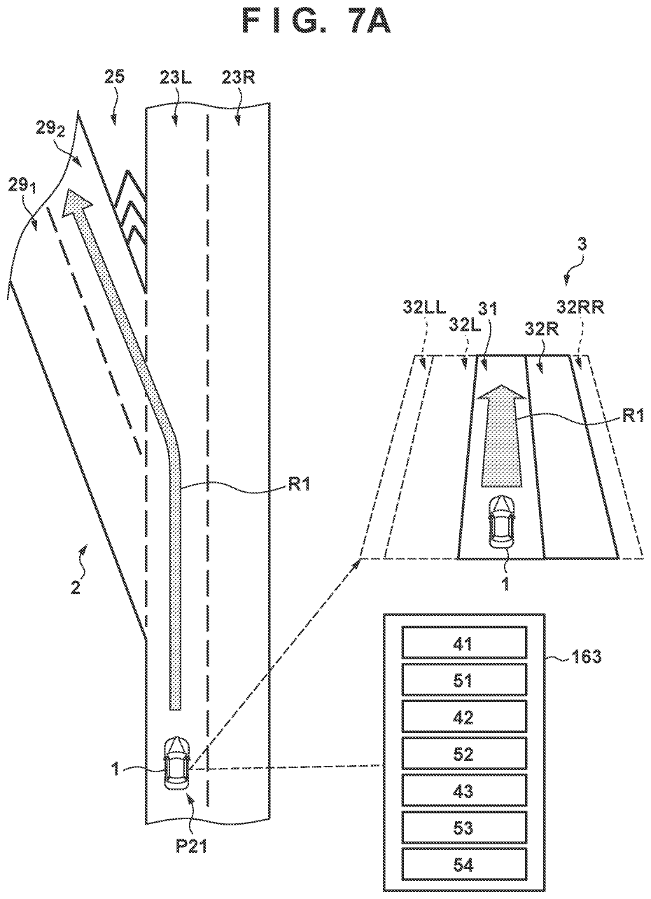

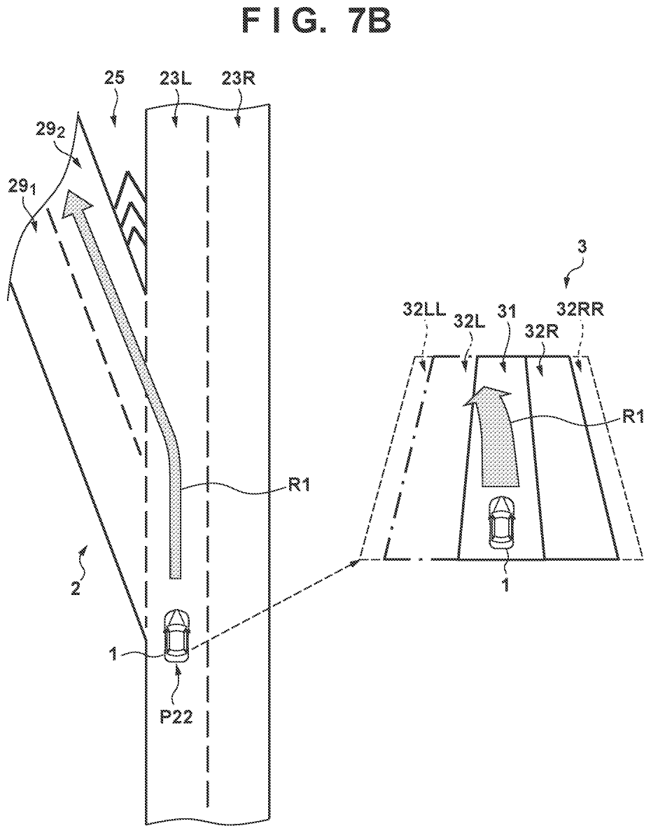

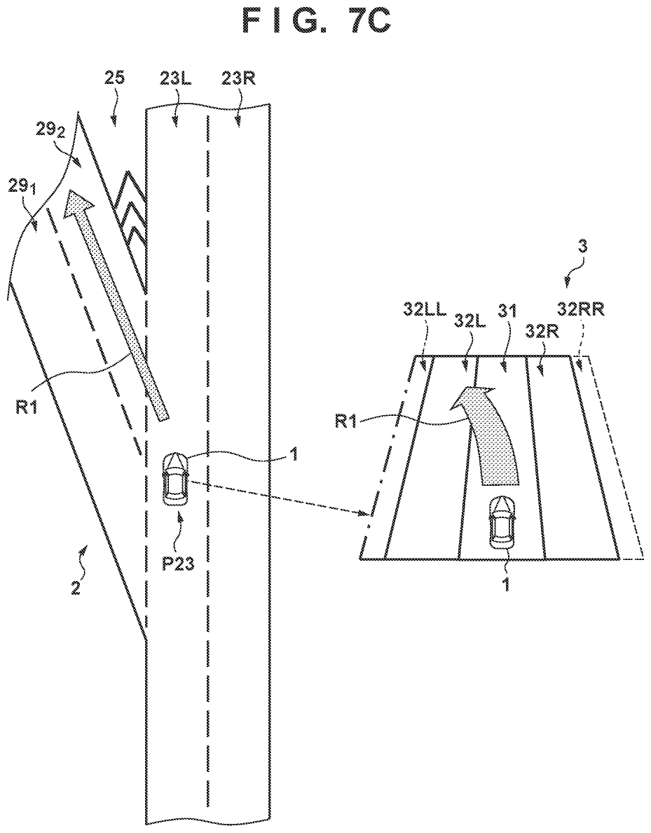

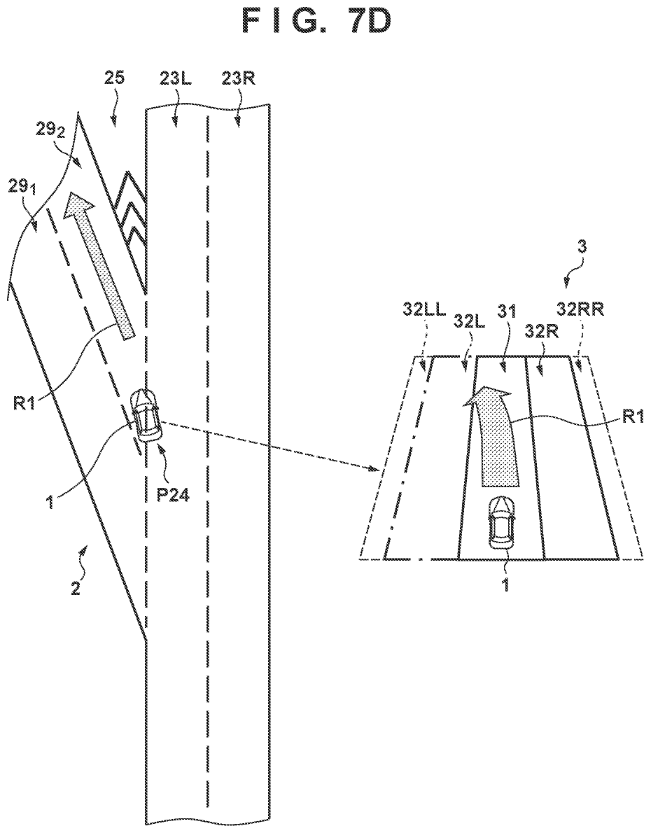

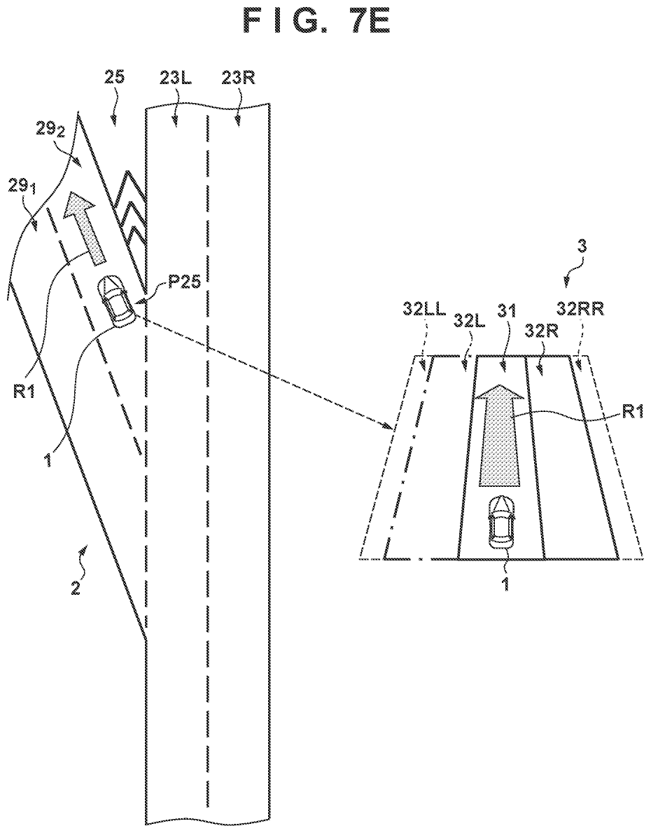

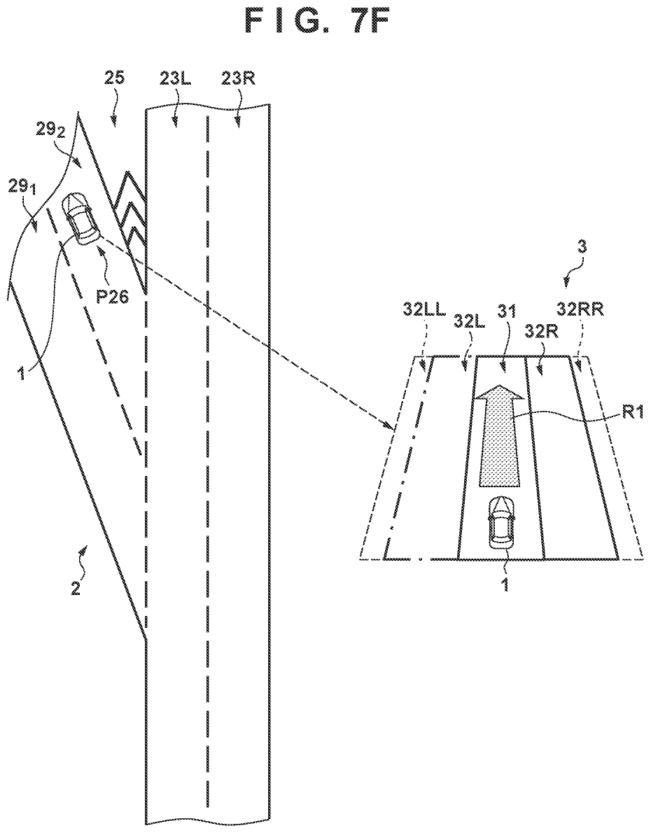

The state of the traveling path 2 according to a fourth example and a display mode of the corresponding display image 3 will be described with reference to FIGS. 7A to 7F. In the present example, the driving assistance apparatus 19 determines a travel route (defined as “travel route R1” in the present example) of the self-vehicle 1, and controls the drive of the driving operation device 12 based on the travel route R1. In the present example, it is assumed that the self-vehicle 1 travels straight in the lane 23L along the travel route R1, and then moves from the lane 23L to the branch lane 29₂.

FIGS. 7A to 7F show the states of points P21 to P26 on the travel route R1, respectively. Between points P21 and P22, the adjacent lane 23R exists which is located adjacent to the current lane 23L. The branch lane 29₁ starts at point P22 and gradually increases in width between points P22 and P23. Then, the branch lane 29₂ starts at point P23 and gradually increases in width. Then, the vehicle 1 moves from the current lane 23L to the branch lane 29₂ between points P23 and P24. The lane 23L is separated from the branch lane 29₂ at point P25. Then, the vehicle 1 reaches point P26. Note that, for ease of understanding, it is assumed that the other vehicles 1X₁ and 1X₂ are not traveling.

The image processing ECU 163 further includes a display unit 54. The display unit 54 causes the display device 15 to display the travel route R1 in such a way as to superimpose the travel route R1 on information displayed by the display unit 51. In the present example, the travel route R1 is displayed as the display image 3 on the display device 15 on the basis of a position relative to the self-vehicle 1.

As shown in FIG. 7A, at point P21, the display unit 51 provides the display image 3 in which the current lane 31 and the adjacent lane 32R on the right side thereof are displayed. As described above, the travel route R1 is displayed on the basis of its position relative to the self-vehicle 1. At point P21, forward movement continues for a predetermined period. Thus, the travel route R1 is indicated by an arrow indicating forward movement in the current lane 31.

As shown in FIG. 7B, at point P22, the display unit 51 provides the display image 3 in which the current lane 31 and the adjacent lane 32R on the right side of the current lane 31 are displayed, and in addition, the branch lane 29₁ is faded in to be newly displayed as the adjacent lane 32L on the left side of the current lane 31. At point P22, the time is approaching to turn to the left. Thus, the travel route R1 is displayed as an arrow extending from the current lane 31 to the newly displayed adjacent lane 32L on the left side in such a way as to indicate a small turn to the left.

As shown in FIG. 7C, at point P23, the display unit 51 provides the display image 3 in which the current lane 31 and the adjacent lane 32R on the right side are displayed and in addition, the adjacent lane 32L indicating the branch lane 29₂ continues to be displayed. Furthermore, the display unit 51 newly displays the lane 32LL indicating the branch lane 29₁ with a fade-in effect. At point P23, the self-vehicle 1 gets much closer to the time of turning to the left. Thus, the travel route R1 is displayed as an arrow extending from the current lane 31 to the adjacent lane 32L on the left side in such a way as to indicate a large turn to the left.

Thereafter, between points P23 and P24, the vehicle 1 changes traveling direction so as to move from the lane 23L to the branch lane 29₂.

As shown in FIG. 7D, at point P24, the vehicle 1 moves from the lane 23L to the branch lane 29₂. Therefore, the branch lane 29₁ exists on the left side of the branch lane 29₂ to be newly regarded as the current lane. The lane 23L exists on the right side of the branch lane 29₂. Another lane, that is, the lane 23R exists on the right side of the lane 23L. Therefore, in the display image 3, while the current lane 31 and the adjacent lanes 32L and 32R continue to be displayed, the lane 32LL is faded out and restrained from being displayed, and the lane 32RR indicating the lane 23R is faded in to be newly displayed. That is, the current lane 31 corresponds to the branch lane 29₂, the adjacent lane 32L corresponds to the branch lane 29₁, the adjacent lane 32R corresponds to the lane 23L, and the lane 32RR corresponds to the lane 23R. At point P24, the time is approaching to complete the turn to the left. Thus, the travel route R1 is displayed as an arrow extending from the current lane 31 to the adjacent lane 32L on the left side in such a way as to indicate a small turn to the left.

As shown in FIG. 7E, at point P25, the lanes 23L and 23R are separated from the branch lane 29₂. Therefore, in the display image 3, while the current lane 31 and the adjacent lane 32L continue to be displayed, the adjacent lane 32R on the right side of the current lane 31, and the lane 32RR on the right side of the adjacent lane 32R are faded out and restrained from being displayed. At point P25, since the turn to the left has been completed, the travel route R1 is indicated by an arrow indicating forward movement in the current lane 31. Thereafter, as shown in FIG. 7F, the same display continues to be provided at point P26.

Note that, as another example, the lane 32RR may be omitted from the display image. This is because the lane 32RR is displayed only between points P24 and P25, and the lane 32RR indicates the lane 23R to be separated from the branch lane 29₂ regarded as the current lane.

According to such a display mode, the travel route R1 continues to be displayed without a significant change, and it is thus possible to avoid confusing an occupant. As a result, it is possible to enable the occupant to easily grasp the state of surroundings of the vehicle 1.

(Others)

In each of the above-described examples, for ease of understanding, other lanes existing on the right side and left side of the self-vehicle 1 have been described as lanes adjacent to the current lane. However, the other lanes just need to be substantially close to the current lane in a direction crossing the traveling direction of the self-vehicle 1. Therefore, the adjacent lanes described in the present specification just need to be adjacent to the current lane at least in the direction crossing the traveling direction of the self-vehicle 1.

In the above description, for ease of understanding, each element has been given a name related to its functional aspect. Meanwhile, each element is not limited to one having, as a main function, the function described in the embodiment, and may be one having the function as an auxiliary function. Therefore, each element is not strictly limited to wording, and the wording can be replaced with similar wording. For the same purpose, the term “apparatus” may be replaced with “unit”, “component”, “piece”, “member”, “structure”, “assembly”, or the like, or may be omitted.

(Summary of Embodiment)

A first aspect relates to an image processing apparatus (for example, 163) to be mounted on a vehicle, the apparatus including:

a first acquisition unit (for example, 41) that acquires information on a traveling path (for example, 2); and a first display unit (for example, 51) that displays the traveling path based on a result of acquisition performed by the first acquisition unit, wherein

in a case where the traveling path includes a current lane (for example, 23L) in which a self-vehicle (for example, 1) is currently traveling and a branch lane (for example, 29₁ or 29₂) diverging from the current lane, the first display unit vertically displays the current lane, and also vertically displays the branch lane as an adjacent lane such that the current lane and the branch lane are horizontally arranged side by side, and

in a case where there are two adjacent branch lanes diverging from one side of the current lane, one of the two branch lanes located closer to the self-vehicle in a traveling direction of the self-vehicle being defined as a first branch lane (for example, 29₁), another branch lane being defined as a second branch lane (for example, 29₂),

the first display unit

displays the first branch lane as the adjacent lane on the one side of the current lane while the current lane is adjacent to the first branch lane, and

then continues to display the adjacent lane such that the second branch lane is displayed as the adjacent lane, instead of the first branch lane while the current lane is adjacent to the second branch lane.

As a result, it is possible to implement a relatively simple display screen that does not confuse an occupant.

In a second aspect,

while the current lane is adjacent to the second branch lane, the first display unit further displays at least part of another adjacent lane indicating the first branch lane on the one side of the adjacent lane indicating the second branch lane.

As a result, the display screen can be simplified.

In a third aspect,

the image processing apparatus further includes:

a second acquisition unit (for example, 42) that acquires information indicating a position of another vehicle relative to the self-vehicle, the another vehicle traveling in vicinity of the self-vehicle; and

a second display unit (for example, 53) that displays the another vehicle in such a way as to superimpose the another vehicle on information displayed by the first display unit, based on a result of acquisition performed by the second acquisition unit.

This makes it possible to prevent an occupant from being confused by the behavior of another vehicle.

In a fourth aspect,

the second acquisition unit acquires the information indicating the relative position of the another vehicle based on a result of monitoring performed by a vehicle-mounted monitoring device (for example, 13).

As a result, the relative position of the another vehicle can be appropriately acquired.

In a fifth aspect,

the second display unit displays the relative position of the another vehicle based on the result of acquisition performed by the second acquisition unit, regardless of the information displayed by the first display unit.

As a result, it is possible to implement a relatively simple display screen that does not confuse an occupant.

In a sixth aspect,

the information indicating the relative position of the another vehicle indicates a horizontal offset distance between the another vehicle and the self-vehicle.

This makes it easy for an occupant to appropriately grasp the relative position of another vehicle.

In a seventh aspect,

in a case where a horizontal offset distance between first another vehicle and the self-vehicle is equal to a horizontal offset distance between second another vehicle and the self-vehicle, the first another vehicle traveling in the first branch lane, the second another vehicle traveling in the second branch lane:

the second display unit displays the first branch lane as the adjacent lane, and also displays both the first another vehicle and the second another vehicle in the adjacent lane while the current lane is adjacent to the first branch lane; and

the second display unit displays the second branch lane as the adjacent lane, and also displays both the first another vehicle and the second another vehicle in the adjacent lane while the current lane is adjacent to the second branch lane.

This makes it possible to prevent an occupant from being confused by the behavior of another vehicle.

In an eighth aspect:

in a case where the branch lane diverges from the current lane, the first display unit displays the adjacent lane with a fade-in effect, and

in a case where the branch lane is separated from the current lane, the first display unit restrains the adjacent lane from being displayed by fading out the adjacent lane.

This achieves a display mode that makes it easy for an occupant to visually recognize a display image. Note that, according to the embodiment, this does not include a case where the second branch lane (for example, 29₂) is displayed when two adjacent branch lanes (for example, 29₁ and 29₂) diverge from one side of the current lane.

In a ninth aspect,

the image processing apparatus further includes:

a third acquisition unit (for example, 43) that acquires information indicating a position of a fallen object (for example, 7₁ or 7₂) relative to the self-vehicle, the fallen object being in vicinity of the self-vehicle; and

a third display unit (for example, 53) that displays the fallen object in such a way as to superimpose the fallen object on information displayed by the first display unit, based on a result of acquisition performed by the third acquisition unit, wherein

in a case where the branch lane diverges from the current lane and the fallen object is located in the branch lane, the third display unit displays the fallen object in association with the adjacent lane faded in and displayed by the first display unit, and

in a case where the branch lane is separated from the current lane and the fallen object is located in the branch lane, the third display unit restrains the fallen object from being displayed, in association with the adjacent lane faded out and restrained by the first display unit from being displayed.

As a result, it is possible to implement a relatively simple display screen that does not confuse an occupant.

In a tenth aspect,

the case where the branch lane is separated from the current lane includes a case where a traveling prohibited zone (for example, 25) is provided between the current lane and the branch lane.

This makes it easy for an occupant to appropriately grasp the state of surroundings of the self-vehicle.

An eleventh aspect relates to a driving assistance apparatus (for example, 19) including:

the image processing apparatus (for example, 163) described above; and

a display device (for example, 15) that displays the traveling path and the self-vehicle.

That is, the image processing apparatus described above can be applied to a typical driving assistance apparatus.

A twelfth aspect relates to a vehicle (for example, 1) including:

the driving assistance apparatus (for example, 19) described above; and wheels (for example, 11).

That is, the driving assistance apparatus described above is applicable to a typical vehicle.

In a thirteenth aspect, the vehicle further includes:

a driving operation device (for example, 12) to be used for driving operation of the vehicle, wherein

the driving assistance apparatus is capable of determining a travel route (for example, R1) of the self-vehicle, and controlling drive of the driving operation device based on the travel route, and

the image processing apparatus further includes a fourth display unit (for example, 54) that displays the travel route in such a way as to superimpose the travel route on information displayed by the first display unit.

This makes it possible to implement a relatively simple display screen that does not confuse an occupant even in the case of automated driving or driving assistance.

In a fourteenth aspect,

when the travel route passes through the second branch lane, the fourth display unit displays the travel route in such a way as to superimpose the travel route on the adjacent lane indicating the first branch lane while the current lane is adjacent to the first branch lane.

As a result, the travel route continues to be displayed without a significant change, and it is thus possible to avoid confusing an occupant.

The invention is not limited to the foregoing embodiments, and various variations/changes are possible within the spirit of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus to be mounted on a vehicle, the apparatus comprising:
a first acquisition unit that acquires information on a traveling path; and
a first display unit that displays the traveling path based on a result of acquisition performed by the first acquisition unit, wherein
in a case where the traveling path includes a current lane in which a self-vehicle is currently traveling and a branch lane diverging from the current lane, the first display unit vertically displays the current lane, and also vertically displays the branch lane as an adjacent lane such that the current lane and the branch lane are horizontally arranged side by side, and
in a case where there are two adjacent branch lanes diverging from one side of the current lane, one of the two branch lanes located closer to the self-vehicle in a traveling direction of the self-vehicle being defined as a first branch lane, another branch lane being defined as a second branch lane,
the first display unit
displays the first branch lane as the adjacent lane on the one side of the current lane while the current lane is adjacent to the first branch lane, and
then continues to display the adjacent lane such that the second branch lane is displayed as the adjacent lane, instead of the first branch lane while the current lane is adjacent to the second branch lane.

2. The image processing apparatus according to claim 1, wherein
while the current lane is adjacent to the second branch lane, the first display unit further displays at least part of another adjacent lane indicating the first branch lane on the one side of the adjacent lane indicating the second branch lane.

3. The image processing apparatus according to claim 1, further comprising:
a second acquisition unit that acquires information indicating a position of another vehicle relative to the self-vehicle, the another vehicle traveling in vicinity of the self-vehicle; and
a second display unit that displays the another vehicle in such a way as to superimpose the another vehicle on information displayed by the first display unit, based on a result of acquisition performed by the second acquisition unit.

4. The image processing apparatus according to claim 3, wherein
the second acquisition unit acquires the information indicating the relative position of the another vehicle based on a result of monitoring performed by a vehicle-mounted monitoring device.

5. The image processing apparatus according to claim 3, wherein
the second display unit displays the relative position of the another vehicle based on the result of acquisition performed by the second acquisition unit, regardless of the information displayed by the first display unit.

6. The image processing apparatus according to claim 3, wherein
the information indicating the relative position of the another vehicle indicates a horizontal offset distance between the another vehicle and the self-vehicle.

7. The image processing apparatus according to claim 6, wherein
in a case where a horizontal offset distance between first another vehicle and the self-vehicle is equal to a horizontal offset distance between second another vehicle and the self-vehicle, the first another vehicle traveling in the first branch lane, the second another vehicle traveling in the second branch lane:
the second display unit displays the first branch lane as the adjacent lane, and also displays both the first another vehicle and the second another vehicle in the adjacent lane while the current lane is adjacent to the first branch lane; and
the second display unit displays the second branch lane as the adjacent lane, and also displays both the first another vehicle and the second another vehicle in the adjacent lane while the current lane is adjacent to the second branch lane.

8. The image processing apparatus according to claim 1, wherein
in a case where the branch lane diverges from the current lane, the first display unit displays the adjacent lane with a fade-in effect, and
in a case where the branch lane is separated from the current lane, the first display unit restrains the adjacent lane from being displayed by fading out the adjacent lane.

9. The image processing apparatus according to claim 8, further comprising:
a third acquisition unit that acquires information indicating a position of a fallen object relative to the self-vehicle, the fallen object being in vicinity of the self-vehicle; and
a third display unit that displays the fallen object in such a way as to superimpose the fallen object on information displayed by the first display unit, based on a result of acquisition performed by the third acquisition unit, wherein
in a case where the branch lane diverges from the current lane and the fallen object is located in the branch lane, the third display unit displays the fallen object in association with the adjacent lane faded in and displayed by the first display unit, and
in a case where the branch lane is separated from the current lane and the fallen object is located in the branch lane, the third display unit restrains the fallen object from being displayed, in association with the adjacent lane faded out and restrained by the first display unit from being displayed.

10. The image processing apparatus according to claim 8, wherein
the case where the branch lane is separated from the current lane includes a case where a traveling prohibited zone is provided between the current lane and the branch lane.

11. A driving assistance apparatus comprising:
the image processing apparatus according to claim 1; and
a display device that displays the traveling path and the self-vehicle.

12. A vehicle comprising:
the driving assistance apparatus according to claim 11; and wheels.

13. The vehicle according to claim 12, further comprising:
a driving operation device to be used for driving operation of the vehicle, wherein
the driving assistance apparatus is capable of determining a travel route of the self-vehicle, and controlling drive of the driving operation device based on the travel route, and
the image processing apparatus further includes a fourth display unit that displays the travel route in such a way as to superimpose the travel route on information displayed by the first display unit.

14. The vehicle according to claim 13, wherein
in a case where the travel route passes through the second branch lane, the fourth display unit displays the travel route in such a way as to superimpose the travel route on the adjacent lane indicating the first branch lane while the current lane is adjacent to the first branch lane.
